(19) United States
(12) Patent Application Publication
(10) Pub. No.: US 2008/0197020 A1
(43) Pub. Date: Aug. 21, 2008

(54) Method for Producing Painted, Flat Metallic Moulded Bodies

(75) Inventors: Helmut Witteler, Wachenheim (DE); Alexander Gothlich, Mannheim (DE); Thomas Heidenfelder, Dannstadt-Schauernheim (DE); Walter Bertkau, Ludwigshafen (DE); Frank Klippel, Ludwigshafen (DE); Gunnar Schornick, Neuleiningen (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/917,293

(22) PCT Filed: Jun. 13, 2006
(86) PCT No.: PCT/EP2006/063170

§ 371 Date: Dec. 12, 2007

(30) Foreign Application Priority Data
Jun. 14, 2005 (DE) 102005027633.4

(51) Int. Cl. C25D 5/00; B05D 3/00

(52) U.S. Cl. 205/80; 427/299; 427/328

(57) ABSTRACT

Flat shaped bodies which comprise at least one metallic layer, a conversion coat applied thereto, and at least one paint coat, and methods for producing such bodies starting from flat, metallic, semifinished products.

Present invention flat, shaped bodies which comprise at least one metallic layer, a conversion coat applied thereto, and at least one paint coat, and also a method for producing such bodies starting from flat, metallic, semifinished products.

The raw material nowadays typically used for producing thin-walled shaped metallic parts from metal sheets, such as automobile parts, bodywork parts, appliance casings, exterior architectural facings, ceiling panels or window profiles, for example, constitutes long metal strips which are produced by hot rolling and/or cold rolling from metal blocks and which for purposes of storage and transportation are wound up into rolls (referred to as coils). To produce the shaped parts, the metal strips are divided up and shaped by means of appropriate techniques such as punching, drilling, folding, profiling and/or deep-drawing to form the desired shaped parts. Larger components, such as automobile bodies, for example, are assembled, if appropriate, by the joining of two or more individual parts.

The aforementioned metallic components must in general be protected against corrosion. This corrosion control treatment takes place typically in multistage operations, and the surface of treated metallic shaped parts has two or more different coats. Typically first of all here the actual corrosion control coat is applied. A coat of this kind is also known as a passivation coat or conversion coat. For further enhancement, additional (paint) coats can be applied to the corrosion control coats. They may form a combination of two or more paint coats each serving different purposes. They serve, for example, to protect the passivation coat and the metal from corrosive gases and/or liquids, but also from mechanical damage, such as stone chipping, and of course they also serve aesthetic purposes. Paint coats are typically much thicker than corrosion control coats. Typical thicknesses range from 4 μm to 400 μm.

A corrosion control treatment can be performed at different points in the production operation. It may involve both temporary corrosion control and permanent corrosion control. For example, a corrosion control treatment can be carried out after a shaped part has been produced, in other words on the shaped workpiece, followed by painting of the workpiece.

A temporary protection is applied, for example, only for the storage or transportation of a metal strip or other metallic workpiece, and is removed again prior to ultimate processing. A temporary coating may also serve other purposes, an example being to improve the working properties during further processing, such as deep-drawing, for example.

Of particular importance both technically and economically are galvanized surfaces. The corrosion control afforded by the zinc derives from the fact that it is baser than the metallic material itself, and therefore initially corrodes itself. The metallic material per se remains intact as long as it is still continuously covered with zinc. Also of importance are metal strips of aluminum or aluminum alloys. In the presence of atmospheric oxygen, a thin oxide layer forms initially on the surface of Zn or Zn alloys, Al or Al alloys, and, depending on the external conditions, it slows down, to a greater or lesser extent, the corrosive attack on the underlying metal.

In the course of an additional corrosion control treatment the metallic surface is treated with an appropriate formulation. In the course of such treatment, some of the metal dissolves and is incorporated straight away back into an oxidic film on the metal surface. This film resembles the oxide film which is present in any case, but offers greater protection, partly owing to the fact that it adheres more strongly and is denser than the oxide film. It is typically referred to as a passivation coat. Generally speaking, it also enhances the adhesion of paint coats that are applied to the metal. Instead of the term “passivation coat” therefore, the term “conversion coat” is frequently used synonymously, and sometimes the term “pretreatment coat” as well. A passivation coat applied to steel strip immediately after galvanizing is occasionally also referred to as an “aftertreatment coat”. Passivation coats are comparatively thin and typically have a thickness of not more than 3 μm.

Generating passivation coats of this kind on zinc or aluminum surfaces by treating the workpiece to be protected with aqueous, acidic solutions comprising chromates is known. The mechanism of this kind of passivation is complex. One of the processes at play is the dissolution of metallic Zn or Al from the surface and its reprecipitation in the form of amorphous zinc chromium oxides or aluminum chromium oxides, respectively. The coats, however, may also include foreign ions and/or other components from the treatment solution. In the case of treatment with chromic acid, in particular, the incorporation of a certain fraction of Cr(VI) into the passivation coat is also desired.

In order to avoid treatment with Cr(VI) solutions, treatments with acidic, aqueous Cr(III) solutions have been proposed. Reference may be made, for example, to U.S. Pat. No. 4,384,902 or WO/40208. Increasingly, however, there are applications which require completely chrome-free passivation processes, owing for example to statutory provisions affecting the construction of automobiles and electrical appliances, or to the wish to reliably rule out contact of foodstuffs with unwanted heavy metal compounds. For the purpose of avoiding the use of Cr(VI) and Cr(III), therefore, the use of polymers is increasingly gaining in importance. Furthermore, on grounds of toxicology and/or the environment, there is a desire to forego cobalt, hydrofluoric acid, fluorides, and hexafluorometallates when pretreating metal surfaces.

DE-A 195 16 765 discloses a chrome-free and fluoride-free method of generating conversion coats on metallic surfaces of Zn or Al. The acidic solution used for passivating comprises a water-soluble polymer, phosphoric acid, and Al chelate complexes. Optionally it is also possible to use polymers and co(polymers) of (meth)acrylic acid.

DE-A 197 54 108 discloses a chrome-free aqueous corrosion control composition which comprises hexafluoro anions of Ti(IV) and/or Zr(IV), vanadium ions, cobalt ions, and phosphoric acid. As an option it is also possible to add various film-forming polymers, including carboxyl-containing copolymers such as acrylic acid/maleic acid copolymers.

WO 02/31064 discloses a method of coating a metallic strip, the strip first being coated with a corrosion control coat and/or with a paintlike polymer-containing coat, then divided up into strip sections, the coated strip sections being worked and joined and thereafter coated with a paint coat. The paintlike coat can also be applied directly to the metal and is by coating with a formulation comprising water, a water-soluble polymer having an acid number of 5 to 200, a finely divided inorganic compound, and also a lubricant and/or corrosion inhibitor.

EP-A 752 453 and EP-A 846 733 disclose the use of polyacids such as homopolymers or copolymers of carboxylic acids containing double bonds, or phosphonic acids, in combination with polymers having a glass transition temperature of more than 100° C. and/or low molecular mass carboxylic acids, for corrosion control tie coats beneath a coating directly on a sheet metal surface. A method for producing painted shaped bodies from flat semifinished products with a metallic surface is not disclosed.

WO 2004/74372 discloses a method of forming a passivation coat on a metal surface, using copolymers of 50% to 99.9% by weight (meth)acrylic acid, 0.1% to 50% by weight more acidic comonomers, and, optionally, further comonomers.

WO 2005/42801 discloses a substantially chrome-free method of passivating metallic surfaces, using a polymer which comprises at least 50% by weight (meth)acrylic acid units. The passivation coat is crosslinked. Neither document, however, discloses methods for producing painted shaped bodies from flat semifinished products with a metallic surface.

It was an object of the invention to provide an improved, preferably chrome-free method for producing painted, metallic, shaped bodies starting from flat semifinished product with a metallic surface, such as metal sheets or metal strips, for example. The method ought additionally, preferably, to be fluoride-free, nickel-free, and cobalt-free.

Found accordingly has been a method for producing painted, flat, shaped bodies comprising at least one metallic layer, using as starting material at least one flat metallic semifinished product, the method comprising at least the following steps:
I) processing the metallic semifinished products and/or the semifinished products coated in accordance with (III) and/or (IV) to shaped bodies,
II) cleaning the metallic surface,
III) applying a conversion coat to the metallic surface by treating the metallic surface with an acidic aqueous preparation Z1, and
IV) applying at least one paint coat to the surface treated with the conversion coat,
   and where the acidic preparation Z1 comprises at least one water-soluble copolymer X comprising at least two different acid-group-containing monomers and containing at least 0.6 mol of acid groups/100 g, the pH of the formulation being not more than 5, and the amount of the polymer being 1% to 40% by weight, based on the amount of all the components of the preparation.

In one preferred embodiment of the invention the water-soluble copolymer X is a copolymer X1 which is constructed from the following monomeric units—based in each case on the amount of all the monomers copolymerized into the copolymer:
(A) 40% to 99.9% by weight of (meth)acrylic acid,
(B) 0.1% to 60% by weight of at least one further monoethylenically unsaturated monomer other than (A), which contains one or more acidic groups, and
(C) optionally 0% to 30% by weight of at least one further ethylenically unsaturated monomer other than (A) and (B).

Found in a further embodiment of the invention have been shaped bodies which comprise at least one metallic layer, a conversion coat applied thereto, and at least one paint coat the conversion coat comprising at least one polymer X.

Details of the invention now follow:

The method of the invention produces painted, flat, shaped bodies which comprise at least one metallic layer. They further comprise a conversion coat and at least one paint coat.

The term “flat” is intended to denote that the shaped bodies in question have a thickness considerably less than their extent in the other dimensions. Generally speaking, the thickness of the shaped bodies is less than 12 mm, preferably less than 6 mm, more preferably less than 4 mm, and, for example, 0.25 to 2 mm. The shaped bodies may be either planar or nonplanar, and may for example have curved surfaces, straight or curved edges or angles. They may also be hollow bodies or tubes and profiles. In those cases the term “thickness” refers to the wall thickness. These kinds of shaped body include, in particular, those bodies which can be used for lining, masking or cladding. Examples include automobile bodies or parts thereof, truck bodies, frames for two-wheeled vehicles such as motorcycles or bicycles, or parts for vehicles of this kind, such as farrings or panels, casings for household appliances such as washing machines, dishwashers, laundry dryers, gas and electric ovens, microwave ovens, chest freezers or refrigerators, casings for industrial appliances or installations such as, for example, machines, switching cabinets, computer housings or the like, structural elements in the architectural sector, such as wall parts, facing elements, ceiling elements, window profiles, door profiles or partitions, furniture made from metallic materials, such as metal cupboards, metal shelves, parts of furniture or else fittings. The bodies may also be hollow bodies for storage of liquids or other substances, such as, for example, tins, cans or tanks.

The starting material for the method of the invention is at least one flat metallic semifinished product. The term “semifinished product” refers, conventionally, to prepared or pre-prepared raw materials for manufacturing, typically in relatively large dimensions. Generally speaking, such semifinished product is composed exclusively of metals. It may be a single-layered material or else a material in which two or more layers of different metals follow one another. Preference is given to two-dimensional materials such as metal plates, metal sheets, metal strips or metal foils. Other profiles, however, may also be involved. Preference is given to metal sheets or metal strips, and particular preference to metal strips. In general the metallic semifinished products used have a thickness of not more than 10 mm, preferably not more than 5 mm, more preferably not more than 3 mm, and, for example, not more than 2 mm.

The term “metallic semifinished product” is also intended to encompass composite materials which have at least one metallic surface and in which at least one metallic layer is joined to at least one nonmetallic layer. The composite material in question may, for example, be a metal foil joined to a polymeric film.

With regard to the metals, particularly the metal sheets or strips, the metal in question may for example be iron or steel, zinc, magnesium, aluminum, tin, copper or alloys of these metals with one another or with other metals. The steels may include both low-alloy and high-alloy steels.

The materials in question are preferably materials having metallic surfaces of Zn or Zn alloys or of Al or Al alloys, and tin. The surface in question may in particular be that of galvanized iron or steel. In one preferred embodiment of the method the surface is that of a strip metal, more particularly strips of electrolytically galvanized or hot-dip galvanized steel.

The term “galvanized” or “zinc-plated” or “aluminized” or “aluminum-plated” also comprises, of course, coating with Zn alloys or Al alloys. Suitable alloys for coating metal strips are known to the skilled worker. Depending on the desired end application, the skilled worker selects the identity and quantity of alloying constituents. Typical constituents of zinc alloys comprise, in particular, Al, Mg, Pb, Fe, Mn, Co, Ni, Si, Mg, Sn, Cu or Cd, preferably Al and/or Mg. The alloys in question can also be Al/Zn alloys in which Al and Zn are present in approximately equal amounts. The coatings may be substantially homogeneous coatings or else coatings which exhibit concentration gradients. The system in question may, for example, comprise galvanized steel which has been additionally vapor-coated with Mg. This may produce, superficially, a Zn/Mg alloy. Steel coated with the alloys described is available commercially. Typical constituents of aluminum alloys comprise, in particular, Mg, Mn, Si, Zn, Cr, Zr, Cu or Ti.

The metallic surfaces for treatment can of course also have thin oxidic/hydroxidic and/or carbonatic surface layers or layers of similar construction. Such layers are typically formed independently on metallic surfaces in contact with the atmosphere, and are included within the term “metallic surface”.

The semifinished product employed as starting material may also already have been protected against corrosion. By way of example the semifinished product may have been greased with corrosion control oils, may have a temporary corrosion control coating or else may have been provided with a removable protective sheet. It will be appreciated that combinations of these measures are possible as well. If protective sheets are present, they are generally removed before the method is implemented. Temporary coatings and/or oils can be removed, if necessary, by means of a cleaning step (II).

In step (I) of the method of the invention the metallic semifinished product is processed to form shaped bodies. This can be done using the starting material itself or else using a semifinished product which has already been coated in accordance with at least one of steps (III) and/or (IV) of the method.

In step (I) of the method it is possible for the skilled worker to use in principle all those techniques which can be used to give flat, shaped bodies of the desired shape from fiat, metallic, semifinished products. Step (I) may comprise two or more substeps. As a general rule, step (I) comprises at least one step selected from the group consisting of parting (Ia), working (Ib), and joining (Ic), preferably at least two steps from said group. It will be appreciated that further substeps may be undertaken as well.

In the case of parting (Ia), the semifinished product used as starting material, in other words, for example, the metal strip or sheet, is divided up into appropriately sized pieces and also, if appropriate, particles of material are separated off from the divided/undivided material for further shaping. The parting techniques used may be either machining techniques or forming techniques. Parting may be accomplished, for example, by punching or cutting using appropriate tools. Cutting may also be undertaken thermally, by means of lasers, for example, or else by means of sharp jets of water. Examples of further parting techniques comprise techniques such as sawing, drilling, milling or filing.

In the case of working (Ib), the semifinished product as it is, or the semifinished product already processed by means of (Ia) and/or (Ic), is worked to produce differently shaped bodies, by means of pliant, plastic change of shape. Working may comprise cold forming or hot forming. Preferably it comprises cold forming. Forming may, for example, involve compressive forming, such as rolling or embossing, tensile compressive forming, such as cold drawing, deep drawing, roll-bending or press-bending, tensile forming such as lengthening or widening, flexural forming such as bending, edge-rolling or edging, and shearing forming such as twisting or dislocating. Details concerning such forming techniques are known to the skilled worker. The operations are also recorded, for example, in the form of relevant standards, such as DIN 8580 or DIN 8584. A method particularly preferred for implementing the present invention is deep drawing.

In the case of joining (Ic), two or more semifinished products or, preferably, semifinished product which has already been processed by (Ia) and/or (Ib) are joined together to form a functional unit. This can be done, for example, by pressing, welding, soldering, adhesive bonding, screwing or riveting. An automobile body, for example, may be joined together from a plurality of individual parts. The starting material used for joining may comprise semifinished products which are each identical, or else different kinds of semifinished products. For example, galvanized steel, ungalvanized steel, and aluminum can be combined with one another to form a shaped body.

From among the possible techniques for implementing step (I) of the method, the skilled worker will make an appropriate selection in accordance with the desired shape of the shaped body. In the case of planar shaped bodies, such as paneling sheets, for example, it may be sufficient just to punch or cut the shape from the semifinished product, to drill holes for mountings, and, if appropriate, to smooth edges. Paneling elements of more complex shape must also be subjected to appropriate working, by means of bending, for example. Larger elements, such as vehicles bodies, for example, can be assembled by joining two or more individual parts.

The individual steps (Ia), (Ib), and (Ic) of the method can also be combined: for example, the steps of parting and working. By way of example, a shaped body can be punched out in one operation and formed by deep drawing.

The method of the invention further comprises at least one cleaning step (II). In this step, impurities and/or unwanted constituents are removed from the surface of the semifinished product. For example, dusts, oils, greases or temporary corrosion control coats can be removed from the surface so as not to interfere with further steps. Cleaning steps may for example involve mechanical cleaning, such as the brushing of the surface. Additionally, the surface can be cleaned by means of suitable liquid media, examples being cleaning in a bath or by spray application. Cleaning with liquid media can be assisted by mechanical means, such as brushes, for example. The cleaning operation may in particular be a degreasing operation on the surface. This degreasing can be performed by means of organic solvents and/or aqueous solutions. Preference is given to degreasing with aqueous alkaline formulations which comprise surfactants. A cleaning step may also comprise pickling or pickling/degreasing. Further information on the process and also on formulations particularly suitable for pickling are disclosed in, for example, WO 2005/033364. After a cleaning step, the surface can optionally then be rinsed off in one or more rinsing steps. It will be appreciated that two or more cleaning steps can also be combined with one another.

A further embodiment of cleaning consists in blowing the surface with compressed air, or subjecting it to suction.

In step (III) of the method a conversion coat is applied to the metallic surface. For this purpose the metallic surface is treated with an acidic aqueous preparation Z1 which comprises at least one water-soluble copolymer X comprising acidic groups. In the course of the treatment there is a change in the chemical nature of the metal surface. This change has the effect, for example, of enhancing the adhesion of subsequent paint coats and of achieving enhanced corrosion control.

The acidic groups are selected preferably from the group of carboxyl groups, sulfonic acid groups, phosphoric acid groups or phosphonic acid groups. With particular preference the acidic groups are carboxyl groups, phosphoric acid groups or phosphonic acid groups.

In accordance with the invention the copolymers X used contain at least 0.6 mol of acid groups/100 g of polymer. This figure relates to the free acid groups. The copolymers preferably contain at least 0.9 mol of acid groups/100 g, more preferably at least 1 mol/100 g, and very preferably at least 1.2 mol/100 g.

The term “water-soluble” for the purposes of this invention is intended to denote that the copolymer or copolymers used are to be substantially homogeneously water-soluble. Aqueous dispersions of crosslinked particles of inherently water-insoluble polymers are not embraced by the scope of this invention. The acid-group-containing copolymers employed ought preferably to be infinitely miscible with water, although this is not absolutely necessary in every case. They must, however, at least be water-soluble to an extent such that conversion coat formation by means of the method of the invention is possible. As a general rule the copolymers used ought to have a solubility of at least 50 g/l, preferably 100 g/l, and more preferably at least 200 g/l.

The skilled worker in the field of water-soluble polymers is aware that the solubility of acid-group-containing polymers in water may be dependent on the pH value. The reference point to be chosen for the solubility ought therefore to be the pH desired for the particular end use. A polymer which at one defined pH has insufficient solubility for the envisaged end use may exhibit sufficient solubility at a different pH.

The copolymer X used is a copolymer of at least two different, acid-group-containing monomers. By way of example it may be a copolymer of (meth)acrylic acid and other acidic monomers such as maleic acid, itaconic acid and/or vinylphosphonic acid. The copolymer may further optionally comprise other monomers without acid-containing groups, as well. The amount of such monomers, however, ought not to exceed 30% by weight, based on the total amount of all of the monomers incorporated by copolymerization into the copolymer.

In one particularly preferred embodiment of the invention the copolymer X comprises one or more water-soluble copolymers X1 composed of (meth)acrylic acid units (A), different, monoethylenically unsaturated monomers containing acidic groups (B), and, optionally, further monomers (C) as structural units.

The monomer (A) for preparing the copolymer X1 is (meth)acrylic acid. It will be appreciated that mixtures of acrylic acid and methacrylic acid can also be used.

The amount of (meth)acrylic acid in the copolymer X1 is 40% to 99.9%, preferably 50% to 90%, and more preferably 50% to 70% by weight, this figure being based on the sum of all the monomers in the polymer.

The monomer (B) is at least one monoethylenically unsaturated monomer other than (A) but copolymerizable with (A), which contains one or more acidic groups. It will be appreciated that two or more different monomers (B) can also be used.

The acidic groups may, for example, be carboxyl groups, phosphoric acid groups, phosphonic acid groups or sulfonic acid groups, without any intention that the invention should thereby be restricted to these acid groups.

Examples of such monomers comprise crotonic acid, vinylacetic acid, C₁-C₄ monoesters of monoethylenically unsaturated dicarboxylic acids, styrenesulfonic acid, acrylamidopropanesulfonic acid, vinylsulfonic acid, vinylphosphonic acid, monovinyl phosphate, maleic acid, fumaric acid or itaconic acid.

The amount of the monomers (B) in the copolymer is 0.1% to 60%, preferably 10% to 50%, and more preferably 30% to 50% by weight, based in each case on the sum of all the monomers in the polymer.

In one preferred embodiment of the invention the monomers (B) are monoethylenically unsaturated dicarboxylic acids having 4 to 7 carbon atoms (B1), and/or monoethylenically unsaturated phosphoric and/or phosphonic acids (B2).

Examples of monomers (B1) comprise maleic acid, fumaric acid, methylfumaric acid, methylmaleic acid, dimethylmaleic acid, methylenemalonic acid or itaconic acid. The monomers can if appropriate also be used in the form of corresponding cyclic anhydrides. Preference is given to maleic acid, fumaric acid, and itaconic acid, particular preference to maleic acid and/or maleic anhydride.

Examples of monomers (B2) comprise vinylphosphonic acid, monovinyl phosphate, allylphosphonic acid, monoallyl phosphate, 3-butenylphosphonic acid, mono-3-butenyl phosphate, mono(4-vinyloxybutyl) phosphate, phosphonoxyethyl acrylate, phosphonoxyethyl methacrylate, mono(-2-hydroxy-3-vinyloxypropyl) phosphate, mono(1-phosphonoxymethyl-2-vinyloxyethyl) phosphate, mono(3-allyloxy-2-hydroxypropyl) phosphate, mono-(2-(allyloxy-1-phosphonoxymethylethyl) phosphate, 2-hydroxy-4-vinyloxymethyl-1,3,2-dioxaphosphole, and 2-hydroxy-4-allyloxymethyl-1,3,2-dioxaphosphole. Preferably B2 is vinylphosphonic acid, monovinyl phosphate or allylphosphonic acid, more preferably vinylphosphonic acid.

Besides the monomers (A) and (B) it is possible optionally to use 0% to 30% by weight of at least one further ethylenically unsaturated monomer (C) other than (A) and (B). In addition to these no other monomers are used.

The monomers (C) serve to fine-tune the properties of the copolymer X1. It is of course also possible to use two or more different monomers (C). They are selected by the skilled worker in accordance with the desired properties of the copolymer and with the further proviso that they must be copolymerizable with the monomers (A) and (B).

Preferably the monomers (C)—as in the case of (A) and (B)—are monoethylenically unsaturated monomers. In particular cases, however, small amounts of monomers having two or more polymerizable groups may also be used. This allows the copolymer to be crosslinked to a slight extent.

Examples of suitable monomers (C) comprise, in particular, alkyl esters or hydroxyalkyl esters of (meth)acrylic acid, such as methyl (meth)acrylate, ethyl (meth)acrylate, butyl (meth)acrylate, 2-ethylhexyl (meth)acrylate, hydroxyethyl (meth)acrylate, hydroxypropyl (meth)acrylate or butane-1,4-diol monoacrylate. Additionally suitable are vinyl or allyl ethers such as methyl vinyl ether, ethyl vinyl ether, propyl vinyl ether, 2-ethylhexyl vinyl ether, vinyl cyclohexyl ether, vinyl 4-hydroxybutyl ether, decyl vinyl ether, 2-(diethylamino)ethyl vinyl ether, 2-(di-n-butylamino)ethyl vinyl ether or methyl diglycol vinyl ether, and the corresponding allyl compounds. It is likewise possible to use vinyl esters such as vinyl acetate or vinyl propionate, for example. Basic comonomers can be used as well, examples being acrylamide and alkyl-substituted acrylamides. Also possible for use are alkoxylated monomers, more particularly ethoxylated monomers. More particularly suitable are alkoxylated monomers which derive from acrylic acid or methacrylic acid.

Examples of crosslinking monomers comprise molecules having two or more ethylenically unsaturated groups, examples being di(meth)acrylates such as ethylene glycol di(meth)acrylate or butane-1,4-diol di(meth)acrylate or poly(meth)acrylates such as trimethylolpropane tri(meth)acrylate or else di(meth)acrylates of oligoalkylene or polyalkylene glycols such as di-, tri- or tetraethylene glycol di(meth)acrylate. Further examples comprise vinyl (meth)acrylate or butanediol divinyl ether.

The amount of all monomers (C) used together is 0% to 30% by weight, based on the total amount of monomers employed. Preferably the amount is 0% to 20% by weight, more preferably 0% to 10%. If crosslinking monomers (C) are present their amount ought in general not to exceed 5%, preferably 2% by weight, based on the total amount of all the monomers used for the method. The amount can for example be 10 ppm to 1% by weight.

In one particularly preferred embodiment of the invention the copolymer X1 besides (A) comprises at least one monomer (B1) and at least one monomer (B2). With further particular preference there are no further monomers (C) present besides the monomers (A), (B1) and (B2).

Preference for the performance of the present invention is given to copolymers X1 of monomers (A), (B1), and (B2) where the amount of (A) is 50% to 90%, the amount of (B1) 5% to 45%, the amount of (B2) 5% to 45%, and the amount of (C) 0% to 20% by weight. (B1) and (B2) may each be only one monomer (B1) and (B2), respectively, or else may each be two or more different monomers (B1) and (B2), respectively.

With particular preference the amount of (A) is 50% to 80%, the amount of (B1) 12% to 42%, the amount of (B2) 8% to 38%, and the amount of (C) 0% to 10% by weight.

With very particular preference the amount of (A) is 50% to 70%, the amount of (B1) 15% to 35%, the amount of (B2) 15% to 35%, and the amount of (C) 0% to 5% by weight.

With particular preference the copolymer is a copolymer X1 of acrylic acid, maleic acid, and vinylphosphonic acid in the abovementioned amounts.

Components (A), (B), and, optionally, (C) can be polymerized with one another in a way which is known in principle. Corresponding polymerization techniques are known to the skilled worker. The copolymers are preferably prepared by free-radical addition polymerization of the stated components (A), (B), and, optionally (C) in aqueous solution. In addition it is also possible for small amounts of water-miscible organic solvents to be present, and also small amounts of emulsifiers if appropriate. Details concerning the conduct of a free-radical addition polymerization are known to the skilled worker.

For preparing the copolymers X1 it is possible in the case of the acidic monomers to make use in each case of the free acids. Alternatively the polymers can also be prepared by using not the free acids in the case of the acidic monomers for polymerization, but instead the acids in the form of their esters, anhydrides or other hydrolyzable derivatives. In the course of or after the polymerization, these esters, anhydrides or other derivatives may undergo hydrolysis in aqueous solution to form the corresponding acid groups. In particular, maleic acid or other cis-dicarboxylic acids may be used advantageously in the form of cyclic anhydrides. These anhydrides undergo very rapid hydrolysis, generally speaking, in aqueous solution to form the corresponding dicarboxylic acids. Other acidic monomers, especially the monomers (A) and (B2), are used preferably as free acids.

The polymerization can additionally be conducted in the presence of at least one base as well. By this means it is possible in particular to improve the incorporation into the polymer of monomers (B1), such as maleic acid, for example, so that the fraction of uncopolymerized dicarboxylic acids is kept low.

Bases suitable for neutralization include, in particular, ammonia, amines, amino alcohols or alkali metal hydroxides. It will be appreciated that mixtures of different bases can also be used. Preferred amines are alkyl amines having up to 24 C atoms, and also amino alcohols which have up to 24 C atoms and also structural units of the type —N—C₂H₄—O— and —N—C₂H₄—OH, and —N—C₂H₄—O—CH₃. Examples of such amino alcohols comprise ethanol amine, diethanol amine, triethanol amine, and their methylated derivatives. The bases may be added before or during the polymerization. It is of course also possible to carry out polymerization without bases and optionally to add base after the polymerization. This permits optimum adjustment of the pH of the polymer.

The degree of neutralization should not be too high, though; instead, there should still be sufficient free acid groups present in the polymer. Free acid groups produce particularly effective adhesion of the polymers on the metallic surface. As a general rule, not more than 40 mol % of the acid groups present in the polymer X or copolymer X1 should be in neutralized form, preferably 0 to 30 mol %, more preferably 0 to 20 mol %, and very preferably 0 to 12 mol %, and, for example, 2 to 10 mol %.

The free-radical polymerization is preferably initiated through the use of suitable thermally activable polymerization initiators.

Initiators which can be used include in principle all of the compounds which undergo decomposition into free radicals under the polymerization conditions. Preference among the thermally activable polymerization initiators is given to those having a decomposition temperature in the range from 30 to 150° C., in particular from 50 to 120° C. This temperature refers, as is usual, to the 10 h half-life.

The skilled worker makes an appropriate selection from the initiators suitable in principle. The free-radical initiators ought to be sufficiently soluble in the solvent of the reaction. If water alone is used as solvent, the initiators ought to possess a sufficient water solubility. If operation is carried out in organic solvents or mixtures of water and organic solvents, organic-soluble initiators can also be used. Preference is given to using water-soluble initiators.

Examples of suitable initiators comprise inorganic peroxo compounds, such as peroxodisulfates, especially ammonium, potassium, and, preferably, sodium peroxodisulfate, peroxosulfates, hydroperoxides, percarbonates, and hydrogen peroxide, and the so-called redox initiators. In certain cases it is advantageous to use mixtures of different initiators, such as mixtures of hydrogen peroxide and sodium or potassium peroxodisulfate, for example. Mixtures of hydrogen peroxide and sodium peroxodisulfate can be used in any desired proportion.

In addition it is also possible to use organic peroxo compounds such as diacetyl peroxide, di-tert-butyl peroxide, diamyl peroxide, dioctanoyl peroxide, didecanoyl peroxide, dilauroyl peroxide, dibenzoyl peroxide, bis(o-toloyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide (water-soluble), cumene hydroperoxide, tert-butyl peroxy-2-ethylhexanoate, and diisopropyl peroxydicarbamate.

Preferred initiators, moreover, are azo compounds. Examples of suitable water-soluble azo compounds comprise 2,2′-azobis[2-(5-methyl-2-imidazolin-2-yl)propane]dihydrochloride, 2,2′-azobis[2-(2-imidazolin-2-yl)propane] disulfate dihydrate, 2,2′-azobis[N-(2-carboxyethyl)-2-methylpropionamidine] tetrahydrate, 2,2′-azobis{2-[1-(2-hydroxyethyl)-2-imidazolin-2-yl]propane} dihydrochloride, 2,2′-azobis{2-methyl-N-[1,1-bis(hydroxymethyl)-2-hydroxyethyl]propionamide, 2,2′-azobis[2-methyl-N-(2-hydroxyethyl)propionamide], 2,2′-azobis[2-(2-imidazolin-2-yl)propane] dihydrochloride, 2,2′-azobis(2-methylpropionamide) dihydrochloride, 2,2′-azobis[2-(3,4,5,6-tetrahydropyrimidin-2-yl)propane] dihydrochloride, 2,2′-azobis[2-(2-imidazolin-2-yl)propane], and 2,2′-azobis{2-methyl-N-[2-(1-hydroxybutyl)]propionamide}.

Examples of azo compounds that are soluble in organic solvents comprise 2,2′-azobis(4-methoxy-2,4-dimethylvaleronitrile), dimethyl 2,2′-azobis(2-methylpropionate), 1,1′-azobis(cyclohexane-1-carbonitrile), 1-[(cyano-1-methylethyl)azo]formamide, 2,2′-azobis(N-cyclohexyl-2-methylpropionamide), 2,2′-azobis(2,4-dimethylvaleronitrile), 2,2′-azobis(2-methylbutyronitrile), 2,2′-azobis[N-(2-propenyl)-2-methylpropionamide], and 2,2′-azobis(N-butyl-2-methylpropionamide).

Further preferred initiators are redox initiators. Redox initiators comprise as their oxidizing component at least one of the abovementioned peroxo compounds and as their reducing component, for example, ascorbic acid, glucose, sorbose, ammonium or alkali metal hydrogen sulfite, sulfite, thiosulfate, hyposulfite, pyrosulfite or sulfide or sodium hydroxymethylsulfoxylate. As the reducing component of the redox catalyst it is preferred to use ascorbic acid or sodium pyrosulfite. Based on the amount of monomers used in the polymerization, for example, 1×10⁻⁵ to 1 mol % of the reducing component of the redox catalyst is used.

In combination with the initiators or redox initiator systems it is possible additionally to use transition metal catalysts, examples being salts of iron, cobalt, nickel, copper, vanadium, and manganese. Suitable salts are, for example, iron(II) sulfate, cobalt(II) chloride, nickel(II) sulfate, copper(I) chloride. The reductive transition metal salt is used typically in an amount of 0.1 to 1000 ppm, based on the sum of the monomers. Particularly advantageous are combinations, for example, of hydrogen peroxide and iron(II) salts, such as a combination of 0.5% to 30% by weight of hydrogen peroxide and 0.1 to 500 ppm of FeSO₄×7H₂O, based in each case on the sum of the monomers.

It is of course also possible to use mixtures of different initiators, provided they have no adverse effects on one another. The amount is specified by the skilled worker in accordance with the desired copolymer. As a general rule, 0.05% to 30%, preferably 0.1% to 15%, and more preferably 0.2% to 8% by weight of the initiator are used, relative to the total amount of all monomers.

In addition it is possible, in a way which is known in principle, to use suitable regulators as well, such as mercaptoethanol, for example. Preferably no regulators are used.

It is preferred to use thermal initiators, in which case water-soluble azo compounds and water-soluble peroxo compounds are preferred. Very particularly preferred are hydrogen peroxide and sodium peroxodisulfate or mixtures thereof in conjunction if appropriate with 0.1 to 500 ppm of FeSO₄×7H₂O.

Alternatively, for example, the polymerization can be triggered by means of appropriate radiation. Examples of suitable photoinitiators comprise acetophenone, benzoin ethers, benzyl dialkyl ketones and derivatives thereof.

The free-radical polymerization is performed preferably at a temperature of less than 130° C. Apart from that, the temperature can be varied by the skilled worker within wide limits, depending on the nature of the monomers employed, the initiator, and the desired properties of the copolymer X1. A minimum temperature which has proven appropriate here is one of about 60° C. During the polymerization the temperature can be kept constant or else it is possible to run temperature profiles. The polymerization temperature is preferably 75 to 125° C., more preferably 80 to 120° C., very preferably 90 to 110° C., and, for example, 95 to 105° C.

The polymerization can be performed in typical apparatus for free-radical polymerization. Where it is operated above the boiling point of the water or of the mixture of water and further solvents, it is carried out in a suitable pressure vessel; otherwise, it can be carried out at atmospheric pressure.

The synthesized copolymers X1 can be isolated from the aqueous solution by means of typical methods known to the skilled worker—such as, for example, by evaporating the solution, spray drying, freeze drying or precipitating.

Preferably, however, the copolymers X1 are not isolated from the aqueous solution at all after the polymerization; instead, the solutions of copolymer solutions obtained are used as they are for the method of the invention.

The method of the invention is carried out using an acidic, aqueous preparation Z1 of the copolymers X. This preparation may of course also be a mixture of two or more different copolymers X. It is preferably composed of copolymers X1.

The molecular weight M_{w} (weight average) of the copolymers X used for the method of the invention is specified by the skilled worker in accordance with the desired application. Use may be made, for example, of polymers having a molecular weight M_{w} of 3000 to 1 000 000 g/mol. Polymers which have proven particularly appropriate are those with 5000 g/mol to 500 000 g/mol, preferably 10 000 g/mol to 250 000 g/mol, more preferably 15 000 to 100 000 g/mol, and very preferably 20 000 to 75 000 g/mol.

As solvent the preparation Z1 preferably comprises water alone. In addition it may comprise water-miscible organic solvents. Examples comprise monoalcohols such as methanol, ethanol or propanol, higher alcohols such as ethylene glycol or polyether polyols and ether alcohols such as butyl glycol or methoxypropanol. As a general rule, however, the amount of water is at least 80%, preferably at least 90%, and more preferably at least 95% by weight. These figures are based in each case on the total amount of all solvents.

With advantage it is possible to employ directly the polymer-containing solutions which result from the polymerization and which at most only require further dilution. In order to make such direct further use more easy, the amount of aqueous solvent used for the polymerization should be calculated from the start such that the concentration of the polymer in the solvent is appropriate for the application.

The concentration of the copolymers X or X1 in the preparation Z1 is 1% to 40% by weight, based on the amount of all components of the formulation. Preferably the amount is 2% to 35% and more preferably 5% to 25% by weight. Through the concentration and the identity of the polymers employed it is possible to influence the properties of the preparation—its viscosity or pH, for example. The properties of the preparation can therefore be tailored optimally to a particular methodology for the treatment. In the case of a technique with squeezing-off, for example, a concentration of 5% to 15% by weight has been found appropriate, a concentration of 15% to 25% by weight in the case of application by means of paint rollers. The stated concentrations refer to the preparation in its ready-to-use form. It is also possible first to prepare a concentrate, which only on site is diluted with water or, optionally, other solvent mixtures to the desired concentration.

The preparation Z1 employed in accordance with the invention has a pH of not more than 5, more particularly a pH of 0.5 to 5, preferably 1.5 to 3.5. The pH of the preparation can be controlled for example through the nature and concentration of the polymers used in accordance with the invention. A critical role is played here, of course, by the degree of neutralization of the polymer.

Furthermore, besides the solvent or solvent mixture and one or more polymers X, the preparation Z1 may optionally also comprise further components.

Optional components include, in particular, organic or inorganic acids or mixtures thereof. There is no limit on the selection of such acid, provided that no adverse effects occur together with the other components of the formulation. The skilled worker makes an appropriate selection.

Examples of suitable acids comprise phosphoric acid, phosphonic acid or organic phosphonic acids such as 1-hydroxyethane-1,1-diphosphonic acid (HEDP), 2-phosphonobutane-1,2,4-tricarboxylic acid (PBTC), aminotri(methylenephosphonic acid) (ATMP), ethylenediaminetetra(methylenephosphonic acid) (EDTMP) or diethylenetriaminepenta(methylenephosphonic acid) (DTPMP), sulfonic acids such as methanesulfonic acid, amidosulfonic acid, p-toluenesulfonic acid, m-nitrobenzenesulfonic acid, and derivatives thereof nitric acid, formic acid or acetic acid. Preference is given to phosphorus acids such as H₃PO₄, phosphonic acid, the stated organic phosphonic acids and/or HNO₃, and particular preference to H₃PO₄. With very particular preference the only acid the formulation comprises, if an additional acid is present at all, is H₃PO₄.

The components present optionally may also be soluble metal ions and metal compounds, examples being those of Al, Mg, Ca, Ni, Co, V, Fe, Zn, Zr, Mn, Mo, W, Ti, Zr. The compounds can be used for example in the form of the respective aqua complexes. Alternatively they may be in the form of complexes with other ligands, such as fluoride complexes of Ti(IV), Zr(IV) or oxo metallates such as MoO₄²⁻ or WO₄²⁻, for example, or else the compounds may be used in the form of complexes with typical chelate-forming ligands such as ethylenediaminetetraacetic acid (EDTA), diethylenetriaminepentaacetic acid (DTPA), hydroxyethylethylenediaminetriacetic acid (HEDTA), nitrilotriacetic acid (NTA) or methylglycinediacetic acid (MGDA). Furthermore it is possible of course for complex compounds with the carboxyl groups of the copolymer X1 to be present. The composition is preferably a fluoride-free composition.

With further preference the method of the invention is a substantially chrome-free method. This is intended to mean that small amounts, if any, of chromium compounds could be added in order to fine-tune the properties of the passivation coat. The amount should not exceed 2% by weight, preferably 1% by weight, and more preferably 0.5% by weight of chromium, based on the copolymers X. If chromium compounds are to be used, then preferably Cr(III) compounds should be used. In any case, however, the Cr(VI) content should be kept so small that the Cr(VI) content on the passivated metal does not exceed 1 mg/m².

With particular preference the method is a chrome-free method, i.e., the preparation employed comprises no Cr compounds at all. The term “chrome-free” does not, however, exclude the entrainment into the method, indirectly and unintentionally per se, of small amounts of chromium. If, indeed, metallic semifinished products comprising chromium as an alloying ingredient are processed by the method of the invention, Cr-containing steel for example, it is always possible that small amounts of chromium in the metal to be treated can be dissolved by the preparation used for the method and, accordingly, may pass unintentionally per se into the preparation. Even when such metals are employed, and the consequences resulting therefrom, the method should be regarded as being “chrome-free”.

The preparation Z1 used in accordance with the invention preferably comprises a soluble metal ion selected from the group of Zn²⁺, Mg²⁺, Ca²⁺ or Al³⁺. The soluble metal ion in question is preferably one selected from the group consisting of Zn²⁺ Mg²⁺ and Ca^{2 +}. With particular preference the metal ions in question are Zn²⁺ or Mg²⁺, and very preferably Zn²⁺. Besides this the preparation preferably comprises no other metal ions.

The amount of the metal ions from the group of Zn²⁺, Mg²⁺, Ca²⁺ or Al³⁺—if present—is generally 0.01% to 25%, preferably 0.5% to 20%, more preferably 1% to 15%, and very preferably 3% to 12% by weight, based in each case on the total amount of all the copolymers X in the formulation.

The preparation Z1 preferably further comprises at least one dissolved phosphate ion. The ion in question may encompass any kinds of phosphate ions. For example it may be from orthophosphates or diphosphates. For the skilled worker it is clear that in aqueous solution, depending on pH and concentration, there may be an equilibrium present between the various dissociation states of the phosphate ions.

Optionally present metal ions, more particularly Zn²⁺, Mg²⁺, Ca²⁺ or Al³⁺, and phosphate ions, can be used preferably in the form of salts which are soluble in the formulation and which comprise both ions. Examples of such compounds comprise Zn₃(PO₄)₂, ZnH₂PO₄, Mg₃(PO₄)₂ or Ca(H₂PO₄)₂, and corresponding hydrates thereof.

Alternatively the ions may be added separately from one another as well. The metal ions, for example, can be used in the form of the corresponding nitrates, and the phosphates can be used in the form of phosphoric acid. It is also possible to use insoluble or sparingly soluble compounds, such as the corresponding carbonates, oxides, oxide hydrates or hydroxides, for example, which are dissolved under the influence of acid.

If present, the amount of phosphate ions in the formulation is specified by the skilled worker in accordance with the desired properties of the formulation. In general it is 0.01% to 25%, preferably 0.5% to 25%, more preferably 1% to 25%, and very preferably 5% to 25% by weight, in each case calculated as orthophosphoric acid and based in each case on the copolymers X.

The preparation Z1 may optionally further comprise at least one wax dispersed in the formulation. It will be appreciated that mixtures of different waxes can also be used. The addition of waxes allows the friction of the surface with the surface of the tools used for working to be lowered advantageously.

The term “wax” here comprises not only the actual wax but also any auxiliaries used in forming a wax dispersion. The skilled worker knows of waxes for use in aqueous dispersions, and makes a suitable selection. The waxes involved may for example be montan waxes, polyethylene waxes, waxes based on oxidized polyethylene, those based on fluorinated polyethylene such as PTFE or other polymers based on C, H, and F. The term “polyethylene” is intended also to comprise copolymers of ethylene and other monomers, more particularly other olefins such as propylene, for example. Ethylene copolymers of this kind preferably comprise at least 65% by weight of ethylene.

Examples of suitable waxes for performing the present invention comprise the following [CAS numbers in square brackets]:
paraffin wax [8002-74-2]
polyethylene wax [9002-88-4]
polyethylene-polypropylene waxes
copolymeric polyethylene waxes, examples being copolymers of ethylene with acrylic acid, methacrylic acid, maleic anhydride, vinyl acetate, vinyl alcohol, examples being [38531-18-9], [104912-80-3], [219843-86-4] or copolymers of ethylene with two or more of these monomers
polybutene waxes
Fischer-Tropsch waxes
oxidized waxes, an example being oxidized polyethylene wax conforming to [68441-17-8]
polar modified polypropylene waxes, an example being [25722-45-6]
microcrystalline waxes, examples being microcrystalline paraffin waxes [63231-60-7]
montan wax and montan wax raffinates, for example [8002-53-7]
montanic acids, for example [68476-03-9]
metal salts of montanic acids, examples being sodium salts [93334-05-5] and calcium salts [68308-22-5]
esters of long-chain carboxylic acids with long-chain alcohols, for example octadecyl stearate [2778-96-3]
montanic esters of polyhydric alcohols, such as
   montan wax glycerides [68476-38-0], including those with partial hydrolysis
   montanic esters of trimethylolpropane [73138-48-4], including those with partial hydrolysis
   montanic esters of 1,3-butanediol [73138-44-0], including those with partial hydrolysis
   montanic esters of ethylene glycol [73138-45-1], including those with partial hydrolysis
montan wax ethoxylates, for example [68476-04-0]
fatty acid amides, for example erucamide [112-84-5], oleamide [301-02-0], and 1,2-ethylenebis(stearamide) [110-30-5]
long-chain ethers, such as octadecyl phenyl ether, for example
carnauba wax.

Also suitable are wax mixtures, examples being
mixtures of octadecyl stearate and partially hydrolyzed montanic esters of polyhydric alcohols
mixtures of paraffin waxes and partially hydrolyzed montanic esters of polyhydric alcohols and/or montanic acids
mixtures of polyethylene wax and polyethylene glycol.

The waxes may also have acid functions, more particularly carboxylic acid groups, which may be in neutralized or unneutralized form. Waxes with an acid number <200 mg KOH/g are preferred. Particularly preferred is an acid number of 3 to 80 mg KOH/g.

Further preferred are waxes which have a melting point. In general the melting point is 40 to 200° C., preferably 60 to 170° C., more preferably 100 to 160° C. Particularly preferred waxes have a melting point of 120 to 135° C. and of 145 to 160° C.

Preferred waxes are oligomeric or polymeric substances which have a molecular weight Mₙ of greater than 200 g/mol, preferably greater than 400 g/mol, and which have a weight fraction of more than 60% by weight of structural elements selected from the group of

(—CH₂—CH₂—)

(—CH₂—CH<)

(—CH₂—CH(CH₃)—)

(—CH₃)

(—CR₂—CR₂—) and (—CR₂—CR(CR₃)—)

where R stands for H and/or F, and with the proviso that the aforesaid structural elements are joined to one another in such a way that they comprise predominantly units of at least 12 carbon atoms linked directly to one another.

Waxes having structural units of this kind may in particular be polyethylene waxes and/or polypropylene waxes and/or derivatives thereof. Waxes of these kinds generally have an average molecular weight Mₙ of 400 to 30 000 g/mol, preferably 1000 to 25 000 g/mol, and more preferably 1500 to 20 000 g/mol. Besides the principal monomers, ethylene and/or propylene, the waxes if appropriate comprise further comonomers as secondary constituents. Further comonomers may for example be other α-olefins, vinyl acetate, or monomers containing acidic groups. Examples of monomers containing acidic groups comprise acrylic acid, methacrylic acid, vinylphosphonic acid, maleic acid or maleic anhydride or vinylacetic acid. Acidic monomers are preferably acrylic acid and/or methacrylic acid. Suitable, for example, are ethylene-(meth)acrylic acid waxes having an ethylene content of 75% to 99% by weight, 1% to 25% by weight of (meth)acrylic acid, and, optionally, 0% to 10% by weight of further monomers. Vinylphosphonic acid and/or vinylphosphonic esters may in particular be involved here.

Examples of derivatives of waxes comprise oxidized polyolefin waxes, especially oxidized polyethylene waxes. Oxidized polyethylene waxes have different oxygen-containing groups on the polyethylene backbone, such as OH groups, keto groups and, more particularly, COOH groups, for example.

The preparation of (oxidized) polyolefin waxes is known in principle to the skilled worker. Details can be taken for example from Ullmann's Encyclopedia of Industrial Chemistry 6th Edition, Electronic Release; Waxes.

Particularly preferred waxes are those which have an as-supplied form that makes them particularly easy to incorporate into the formulation for the method of the invention, such as micronized waxes and/or wax dispersions, for example/

Micronized waxes are particularly fine-particled powders having an average particle size of preferably below 20 μm, more preferably 2 to 15 μm. Wax dispersions are aqueous preparations of waxes that comprise water, optionally further, water-miscible solvents, spherical wax particles, and, generally, auxiliaries. Preferred wax dispersions for use in the context of the present invention have a particle size below 1 μm, preferably 20 to 500 nm, more preferably 50 to 200 nm. Micronized waxes and completed wax dispersion are available commercially.

Auxiliaries are used in wax dispersions in order for example to ensure the dispersibility of the wax and its stability on storage. The auxiliaries may be, for example, bases for neutralization or partial neutralization of acid functions in the wax, examples being alkali metal hydroxides, ammonia, amines or alkanolamines. Acid groups may also be fully or partly neutralized with cations, examples being Ca⁺⁺ or Zn⁺⁺. Further possible auxiliaries are surface-active substances, preferably nonionic surfactants or anionic surfactants. Examples of nonionic surfactants comprise ethoxylates and propoxylates based on alcohols and hydroxyaromatic compounds, and also their sulfation and sulfonation products. Examples of anionic surfactants comprise alkylsulfonates, arylsulfonates, and alkylarylsulfonates.

Particularly suitable for performing the present invention are wax dispersions having a pH of less than 7, preferably having a pH of less than 6.

The amount of waxes employed optionally is determined by the skilled worker in accordance with the desired properties of the passivation coat. An amount which has been found suitable in general is from 0.01% to 40% by weight, preferably 0.5% to 40% by weight, more preferably 0.5% to 20% by weight, and very preferably 0.5% to 10% by weight, based in each case on the acid-group-containing copolymer X.

Further optional components of the preparation Z1 comprise surface-active compounds, corrosion inhibitors, complexing agents, typical galvanizing assistants, or else further polymers, which are to be distinguished from the polymers X used in accordance with the invention. Further possible additives are typical coating additives, of the kind described in H. Kittel (ed.) Lehrbuch der Lacke und Beschichtungen, Volume 5—Pigmente, Füllstoffe und Farbmetrik—2^{nd} ed., S. Hitzel-Verlag, Stuttgart 2003.

From the optional components that are possible in principle, and also in respect of their quantities, the skilled worker makes an appropriate selection in accordance with the desired application. As a general rule, however, the amount of optional components should not amount to more than 20%, preferably not more than 10%, and more preferably not more than 5% by weight, based on the copolymers X.

The preparations used for the method in accordance with the invention, Z1, can be obtained by simple mixing of the components. If waxes are used, they are preferably first dispersed separately in water and mixed in the form of a dispersion with the other components. Wax dispersions of this kind are also available commercially.

For implementing step (III) of the method, the metallic surface is treated with the preparation Z1, by contacting the surface with the preparation, by means for example of immersion.

In the course of this contacting, parts at least of the acidic copolymers X used, and also further components of the preparation Z1, are chemisorbed by the surface of the metal and/or react with the surface, so that a firm bond comes about between the surface and the component. Furthermore, in the course of the treatment, some of the metal to be protected breaks down and is incorporated at least partly into a film on the metal surface. As a result of the use of copolymers X having a high acidic groups content and a low degree of neutralization, the aforementioned partial dissolution of the metal surface is particularly effective, and outstanding corrosion control is obtained.

We do not know the precise structure and composition of the conversion coat or passivation coat. However, in addition to the at least one metallic cation dissolved from the surface, it comprises at least also the polymer X and also, if appropriate, compounds of the metal and also of further components of the formulation. The composition of the conversion coat need not be homogeneous; instead, the components may exhibit a concentration gradient. The amount of the polymer X incorporated into the conversion coat is generally at least 20% by weight, preferably at least 30% by weight, relative to the sum of all of the components of the conversion coat.

With regard to the technique for the implementation of step (III) of the method there exists a series of possibilities. These possibilities are guided by factors which include the shape of the workpiece—for example, whether an unshaped, flat semifinished product, such as a metal strip or a metal sheet, or a shaped body, having curved surfaces or edges, is being used. The treatment may also comprise a plurality of individual steps. The methods in question may be continuous or discontinuous. The skilled worker makes a suitable selection from among the possible methods.

The treatment may be performed, for example, by immersion into the formulation or by spraying or coating with the formulation. On shaped bodies which are flat it is also possible for the formulation to be rolled on.

After an operation of immersion or spraying, excess treatment solution can be removed by allowing the workpiece to drip dry; in the case of metal sheets, metal foils or the like, however, excess treatment solution can also be removed, for example, by squeezing, squeegeeing or spinning. A further possibility is to rinse the surface, after the treatment, with a cleaning liquid, more particularly with water, in order to remove residues of the preparation employed from the surface.

In one particularly preferred embodiment the treatment may also involve a “no-rinse” operation, in which the treatment solution is dried up immediately following its application, without rinsing, in a drying oven, directly.

Treatment with the preparation may take place at room temperature or else at elevated temperatures. Generally speaking, the treatment takes place at 20 to 100° C., preferably 25 to 80° C., and more preferably 30 to 60° C. This can be done, for example, by heating a bath containing the preparation; alternatively, an elevated temperature may come about automatically, by immersing hot metal in a bath.

Treating the metal surface with the preparation can be done discontinuously or, preferably, continuously. A continuous process is suitable especially for the treatment of strip metals. In that case the metal strip is run through a trough or a spraying apparatus containing the preparation.

Also with particular advantage, metal strips can be coated by roller application of the preparation. In the case of roller application, the coating material is generally picked up from a trough by a pickup roll and then transferred to an applicator roll. The applicator roll transfers the coating material to the strip. Pickup and applicator roll may be coupled via a roll located in between, via which the coating material is transferred. The rolls may rotate in the same direction or in opposite directions and may run with or against the strip direction. The coating outcome may additionally be determined by the choice of the contact pressure of the roll on the strip, and through the roughness and hardness of the roll.

The duration of treatment is specified by the skilled worker in accordance with the desired properties of the coat and of the composition used for the treatment, and with the technical conditions prevailing. It may be much less than a second, or may be two or more minutes. In the case of the continuous method, it has proven particularly appropriate to contact the surface with the preparation for a time of from 1 to 60 s.

Following the treatment, the solvent used, i.e., generally, water, is removed. It can be removed at room temperature by simple evaporation in air at room temperature.

Alternatively the removal of the solvent may be assisted by suitable auxiliary means, such as by heating and/or by passing gas streams over the material, more particularly air streams. The evaporation of the solvent can be assisted, for example, by means of IR lamps, or else, for example, by drying in a drying tunnel. For drying, a temperature of 30° C. to 210° C. has proven useful, preferably 40° C. to 120° C. and more preferably 40° C. to 80° C. The temperature referred to here is the peak metal temperature (PMT) found on the metal, and can be measured by techniques familiar to the skilled worker (for example, contactless infrared measurement or temperature determination using adhered test strips). It may be necessary to set the dryer temperature at a higher level, the temperature being chosen appropriately by the skilled worker.

The conversion coat can also be crosslinked additionally. For this purpose a crosslinker can be admixed to the preparation. Alternatively the metal can first be treated with the preparation and thereafter the coat can be treated with a suitable crosslinker—for example, sprayed with the solution of a crosslinker.

Suitable crosslinkers ought to be water-soluble or at least soluble in the stated aqueous solvent mixture. Examples of suitable crosslinkers comprise in particular those which contain at least 2 crosslinking groups selected from the group of azirane groups, oxirane groups or thiirane groups. Further details of suitable crosslinkers and their use are disclosed in WO 05/042801 p. 11, line 34 to page 14, line 39.

Crosslinking can also be performed by adding to the formulation compounds which comprise more than one OH group and/or NH₂ group, such as alkanolamines, polyhydric alcohols, diamines, oligoamines, and polyamines, for example. These compounds are able to crosslink when the drying temperature is chosen appropriately.

The formulation preferably comprises no crosslinking components, and in particular no readily crosslinkable components such as epoxides, urethanes, aziridines or silanes.

The entire metallic surface of the shaped body can be provided with a conversion coat. Alternatively only part of the metallic surface can be provided with a conversion coat: for example, only the top face of a strip or sheet, and not the bottom face. This is determined by the particular end use envisaged for the shaped body.

The thickness of the conversion coat is set by the skilled worker in accordance with the desired properties of the coat. In general the thickness is 0.01 to 3 m, preferably 0.1 to 2.5 m, and more preferably 0.2 to 1.5 m. The thickness can be influenced by the skilled worker, for example, via the nature of the acidic, aqueous preparation used—for example, its viscosity—and also via the exposure time. It is also possible to influence the thickness by means of technical parameters of the method—for example, by removing treatment solution applied in excess.

In step (IV) of the method at least one paint coat is applied to the conversion-coated surface. The paint system here may also comprise two or more paint coats to be applied in succession, the individual paint coats typically serving different functions. For example, they may be coloring and/or effect paint coats.

The selection of paints is not subject in principle to any restriction, provided that no negative properties arise. They may for example be physically, thermally or radiation-curable paints, liquid paints or powder coating materials, water-based paints or solvent-based systems. Paint systems and their respective preferred end uses are known in principle to the skilled worker. The skilled worker makes an appropriate selection. The paints can be applied by means of techniques known to the skilled worker, as for example by spraying, dipping or rolling.

With preference it is possible to apply at least two different paint coats. The first paint coat is a primer. The purposes of using primers include improving the adhesion of further paint coats applied to them. They also serve, furthermore, for corrosion control, by providing better shielding of the metal surface from the influence of corrosive media. For performing the present invention it is preferred to use water-based primers. Typical primers are disclosed, for example, in EP-A 299 148 or EP-A 401 565.

The primer can also be applied by means of electrodeposition coating. Electrodeposition coating has been found useful in particular for the production of automobile bodies. In electrodeposition coating, the metallic, shaped body to be coated is immersed into a water-diluted paint. With application of an electric direct voltage body between body article and counterelectrode, which is likewise immersed in the paint, colloidal paint particles are deposited on the surface of the shaped body. The electrocoating operation may in particular be one of cathodic electrocoating, where the shaped body constitutes the cathode pole. As binders of the paint formulations it is possible in a manner known in principle to use polymers containing ammonium groups. They can be obtained readily by reacting polymers containing amino groups with acids, carboxylic acids for example. It is preferred to use a slightly acidic electrodeposition paint, having for example a pH of 5 to 7. Further details on the conduct of electrodeposition coating are disclosed for example in DE-A 198 04 291 and Römpp-Lexikon “Lacke urd Druckfarben”, Georg Thieme Verlag, Stuttgart, New York 1998, pp. 188/189.

Atop the primer it is possible to apply one or more topcoats. These, for example, may be color paints and/or clearcoat materials and/or other functional paint materials. An example of a functional paint is a soft paint having a relatively high filler fraction. This kind of paint can be applied to the primer advantageously before the color paint and/or topcoat material, in order to protect the metal and the conversion coat from mechanical damage, caused for example by stone chipping or scratching.

For painting it is also possible to use powder coating materials. These paints can be applied as one-coat paints directly to the conversion coat, or alternatively can be combined with electrocoat materials and/or liquid paints. Powder coating materials, for example, with binders based on epoxy resins, polyesters, isocyanates or acrylates can be used. Further details on the conduct of powder coating operations are disclosed for example in DE-A 196 32 426 or Römpp-Lexikon “Lacke und Druckfarben”, Georg Thieme Verlag, Stuttgart, New York 1998, pp. 477 to 480.

The conversion coat obtained in accordance with the invention using the acidic, aqueous preparation Z1 may also serve as an integrated pretreatment coat, i.e., may be coated directly with topcoat materials without application of a primer. The high quantity of unneutralized COOH groups ensures, advantageously, effective adhesion of subsequent paint coats, especially for aqueous basecoat materials.

The method of the invention can be carried out in the order (I), (II), (III), (IV); in other words, first a shaped body is produced from the metallic semifinished product, and in further steps is cleaned, provided with a conversion coat, and then painted. A procedure of this kind has been found appropriate, for example, for automobile bodies.

In another embodiment the method can also be carried out in the order (II), (III), (IV), (I); in other words, the metallic semifinished product is first cleaned, provided with a conversion coat, and painted, and only then is processed into a shaped body. A procedure of this kind has been found appropriate, for example, in the production of facings and casings for the architectural and appliance segments, starting from metal strips. Here, metal strips are cleaned and coated in a continuous process, known as the coil-coating process, and only thereafter are shaped bodies produced.

It will be appreciated that other orders too are also possible, such as (II), (III), (I), (IV), for example. Furthermore, in the case of painting with two or more coats, for example, application may take place in two or more substeps: for example, in the order (II), (III), (IV), (I), (IV′), by application first of one or more paint coats, such as primers, for example, followed by shaping, and finally by application of one or more further paint coats, such as topcoats, for example.

A cleaning step (II) can also be carried out a number of times in the course of the method. By way of example the surface can in each case be given an intermediate rinse or, preferably, blown with compressed air between steps (II) and (IV) or between the application of individual paint coats in step (IV).

The method of the invention may further comprise, optionally, additional steps, which can be combined suitably with (I) to (IV).

By way of example, steps (I) to (IV) may be followed by at least one aftertreatment step (V). This may involve, for example, the polishing of the surface of the shaped body, or else the surface can be provided with a removable protective film for protection from damage, during transportation, for example. A protective film can be applied, for example, by lamination.

Further possibilities include, for example, roughening the surface of the semifinished product or of the shaped body, and/or the surface of the coated semifinished product or shaped body, in each case, prior to further steps of the method.

In a further preferred embodiment of the method, in a step (0) which precedes steps (I) to (IV), the metallic semifinished product used is protected by means of a removable corrosion control coat. This removable corrosion control coat is applied by treating the metallic surface of the semifinished product with an aqueous, acidic preparation Z2.

Whereas steps (I) to (IV) of the method can in general be carried out at the premises of a further-processing company, such as an automaker, appliance builder, construction fittings manufacturer or coil-coating plant, for example, the preceding step (0) can be carried out preferably at the premises of the manufacturer of the metallic, flat, semifinished product—in other words, for example, a steelmaker, aluminum maker or rolling mill. For example, a metal strip, like a galvanized steel strip after galvanizing, can be provided in a continuous process in a removable corrosion control coat. Such corrosion control coats are frequently also referred to by the skilled worker as “aftertreatment”. By this means the metallic surface can be protected for transportation and/or for the implementation of step (I) of the method.

In principle it is possible to use any desired acidic, aqueous corrosion control formulations as Z2, examples being typical phosphating solutions containing phosphoric acid.

In one preferred embodiment of the invention the preparation Z2, like the preparation Z1, comprises at least water-soluble copolymer X, preferably a copolymer X1. In addition it may comprise further components. In one particularly preferred embodiment of the invention step (0) of the method as well uses a preparation Z1. The corrosion control coat can be applied by the methods already described.

The removable corrosion control coat can be removed at a later point, before step (III) of the method is implemented, in a cleaning step. This can be done with particular advantage using an aqueous alkaline rinsing solution, such as a dilute NaOH solution or NH3 solution having a pH of 9 to 13, at temperatures of 20 to 70° C., for example. However, the corrosion control coat need not be removed in every case; instead, if appropriate, the semifinished product can be subjected to direct further processing.

The painted, flat, shaped body obtainable by the method has at least one metallic layer, a conversion coat, obtainable through treatment with the formulation Z1, and also at least one paint coat. The conversion coat is of course applied directly to the metal layer. It has preferably at least two different paint coats. The composition, structure, and thickness of the conversion coat have already been outlined above.

The conversion coats and paint coats may surround the shaped body completely; however, the invention also comprises shaped bodies in which only one area of the shaped body has the conversion and paint coats, while the remaining area has no such coats or only part of these coats. In one preferred embodiment the shaped body is surrounded at least completely by a conversion coat and a primer, while other paint coats, such as color paints, for example, are applied only to the outside of the shaped body.

The flat, shaped bodies in question are preferably those composed of steel, galvanized steel, aluminum or aluminum alloys. The thickness of the metallic layer is preferably not more than 5 mm, more preferably not more than 3 mm, and, for example, 0.25 to 2.5 mm. Examples of such shaped bodies were mentioned at the outset.

The shaped bodies of the invention have paint coats which adhere well to the metallic surface, and the surface is protected outstandingly against corrosion.

The examples which follow are intended to illustrate the invention more closely:

### Materials Employed

### Copolymer X1: Acrylic Acid/Maleic Acid/Vinylphosphonic Acid Copolymer (Inventive):

Acid-group-containing copolymer of 60% by weight acrylic acid, 20% by weight maleic acid, and 20% by weight vinylphosphonic acid. The amount of the acid groups is 1.37 mol/100 g of polymer. The degree of neutralization of the acid groups is approximately 6 mol % (neutralized with triethanolamine); M_{w} approximately 25 000 g/mol.

### Polyacrylic Acid (Comparative Polymer)

Polyacrylic acid (unneutralized); M_{w} approximately 100 000 g/mol. The amount of acid groups is 1.4 mol/100 g of polymer.

### Formulations Employed:

In each case aqueous solutions of copolymer X1 and of the comparative polymer were used. If appropriate the formulations also comprised Mg₃(PO₄)₂ and also H₃PO₄ in the amounts stated in Table 1. The concentration of the polymers was in each case 20% by weight, relative to the sum of all the components of the formulation,

TABLE 1
Composition of the formulations employed

| Example | 1 | C 1 | C 2 |
|---|---|---|---|
| Copolymer X1 [g] | 64.0 | — | — |
| Comparative polymer (35% solution in | — | 182.9 | 182.9 |
| water) [g] | | | |
| Mg₃(PO₄)₂ [g] | 4.49 | — | 4.49 |
| [wt. %] based on polymer | 7.0% | | 7.0% |
| H₃PO₄ (85%) [g] | 2.56 | — | 2.56 |
| [wt. %] based on polymer | 3.4% | | 3.4% |
| Water [g] | 249 | 137.1 | 130.1 |
| pH | 1.92 | 1.57 | 2.52 |
| Total amount | 320 | 320 | 320 |

### Steel Sheets Used

Test sheets of hot-dip galvanized steel (Gardobond® OE HDG 3, 105×190 mm) were used for the inventive and comparative examples.

Cleaning (step II)

The steel sheets were immersed in an alkaline cleaning solution (Ridoline® C72, Henkel) for 10-20 seconds, rinsed off immediately with fully demineralized water, and then dried with nitrogen.

Application of a Conversion Coat (step III):

The cleaned steel sheets were immersed in the formulations set out in Table 1 for 1 s in each case, at room temperature, and then were squeezed off with a roller system and dried in a drying cabinet at 160° C. for 12 s. The peak metal temperature during drying did not exceed 50° C. 3 steel sheets were coated in each case.

### Working (Step I):

One of the steel sheets coated in each case was deformed from the reverse of the sheet by slow impression of a ball (diameter: 20 mm) in analogy to the procedure for Erichsen tests (DIN 53156). The steel sheets were deformed respectively to an impression depth of 8.4 mm, 8.8 mm, and 9.2 mm.

### Tests

The unworked metal sheets coated with the conversion coat, and also the metal sheets worked in the manner described, were each used for carrying out corrosion tests: specifically, in each case a condensation climatic cycling test with alternation of air humidity and air temperature in accordance with DIN 50017-KFW, and a salt spray mist test (SSK) in accordance with DIN 50021-SS.

### Condensation Climatic Cycling Test (KFW):

The condensation climatic cycling test (DIN 51017) is composed of one or more climatic cycles each with two test sections. In the first section the test specimens are exposed for 8 hours at a temperature of 40° C. and a relative humidity of 100%, while in the second section they are exposed at a temperature of 18-28° C. and a humidity of below 100% (ambient conditions). The duration of one cycle is therefore 24 hours.

The samples were assessed visually on the following criteria:
0 no chalking, coat transparent
1 slight chalking
2 moderate chalking
3 severe chalking
4 very severe chalking

“Chalking” denotes a white haze on the coating. As the degree of chalking increases, the coating becomes continually less transparent.

### Salt Spray Test (SSK)

This spray mist test is a corrosion test standardized in DIN 50021, in which finely sprayed sodium chloride solution is caused to act on the sample. 1.5 ml of solution per hour, based on a surface area of 80 cm², is sprayed with the aid of moistened compressed air onto an inclined sample at 35° C. The solution used was a 5% strength NaCl solution. The coated samples are subjected intact to the test. The test duration is in each case 24 h.

### (A) Evaluation of the Unworked Sheets After SSK:

The quality of corrosion control in the salt spray test was evaluated in accordance with DIN EN ISO 10289, by awarding evaluation numbers from 0 to 10 in accordance with predetermined standards. The evaluation number is a measure of the formation of white rust on the sheet. The higher the evaluation number, the smaller the fraction of the surface area corroded and the better the corrosion control. The evaluation numbers are awarded in accordance with the following table:

| Defect surface area | Evaluation grade |
|---|---|
| % | Rp or R_{A} |
| no defect | 10 |
| 0 < A ≦ 0.1 | 9 |
| 0.1 < A ≦ 0.25 | 8 |
| 0.25 < A ≦ 0.5 | 7 |
| 0.5 < A ≦ 1.0 | 6 |
| 1.0 < A ≦ 2.5 | 5 |
| 2.5 < A ≦ 5.0 | 4 |
| 5.0 < A ≦ 10 | 3 |
| 10 < A ≦ 25 | 2 |
| 25 < A ≦ 50 | 1 |
| 50 < A | 0 |

### (B) Evaluation of the Worked Sheets After SSK:

The corrosion was assessed by inspection in each case at the point of impression. The evaluations awarded were “no corrosion, minimal, slight, moderate, severe”

The results of all the tests are summarized in Table 2.

TABLE 2

| | Example | | |
|---|---|---|---|
| | 1 | C 1 | C 2 |
| Formulation | | | |
| Polymer | AA/MA/VPA copolymer | Polyacrylic acid | Polyacrylic acid |
| mol of acid groups/100 g of polymer | 1.37 | 1.40 | 1.40 |
| Mg₃(PO₄)₂ | 7% | — | 7% |
| H₃PO₄ [85%] | 3.5% | — | 3.4% |
| Assessment of unworked sheets: | | | |
| KFW - Visual assessment of chalking¹ | 1 | 3 | 1.5 |
| SSK - Evaluation grade² | 5 | 0 | 1 |
| Assessment of worked sheets | | | |
| Corrosion - 8.4 mm indentation | minimal | moderate | moderate |
| Corrosion - 8.8 mm indentation | slight | severe | moderate |
| Corrosion - 9.2 mm indentation | moderate | severe | severe |

Results obtained with the formulations. C = comparative examples
¹The higher the evaluation, the poorer.
²The higher the evaluation, the better.

The inventive and comparative examples show that better results are achieved with the copolymers used in accordance with the invention, with more than one acidic monomer, than with the polyacrylic acid homopolymer, which contains a comparable amount of acid groups/100 g, and that these improved results are obtained both on the unworked metal sheets and on the worked metal sheets.

1-20. (canceled)

21. A method for producing painted, flat, shaped bodies comprising at least one metallic layer from at least one flat metallic semifinished product as starting material, comprising:
(2) cleaning the metallic surface;
(3) applying a conversion coat to the metallic surface by treating the metallic surface with an acidic aqueous preparation Z1 comprising at least one water-soluble copolymer X1 comprising:
(A) 50% to 90% by weight of (meth)acrylic acid;
(B) 10% to 50% by weight of at least one further monoethylenically unsaturated monomer other than (A), which contains one or more acidic groups selected from the group consisting of
(B1) monoethylenically unsaturated dicarboxylic acids having 4 to 7 carbon atoms; and
(B2) monoethylenically unsaturated phosphoric and/or phosphonic acids;
and
(C) optionally 0% to 20% by weight of at least one further ethylenically unsaturated monomer other than (A) and (B);
wherein the copolymer X1 contains at least 0.6 mol of acid groups/100 g of the polymer, the pH of the preparation is not more than 5, and the amount of the polymer is 1% to 40% by weight, based on the amount of all the components of the preparation; and
(4) applying at least one paint coat to the surface treated with the conversion coat;
wherein the method further comprises (1) processing into shaped bodies the metallic semifinished products and/or the semifinished products coated in accordance with (3) and/or (4), wherein said processing (1) comprises at least one of parting (1a), working (1b), and joining (1c).

22. The method of claim 21, wherein the metallic surface is the surface of iron, steel, zinc, magnesium, aluminum, tin, copper, or alloys thereof.

23. The method of claim 21, wherein the metallic semifinished product is metal sheets or metal strips.

24. The method of claim 23, wherein the metal sheet or metal strip is one selected from the group consisting of galvanized steel, tin-plated steel, aluminized steel, aluminum, and galvanized aluminum.

25. The method of claim 21, wherein said method is carried out in the order (II), (III), (IV), and (I).

26. The method of claim 21, wherein said method is carried out in the order (II), (III), (I), and (IV).

27. The method of claim 21, wherein said method further comprises (0) applying a removable corrosion control coat by treating the metallic surface of the semifinished product with an aqueous, acidic preparation Z2, wherein (0) precedes (1), (2), (3), and (4).

28. The method of claim 27, wherein the preparation Z2 comprises at least one water-soluble, carboxyl-containing copolymer X1.

29. The method of claim 27, wherein the removable corrosion control coat is removed in (2) using an aqueous alkaline rinsing solution.

30. The method of claim 21, wherein the method further comprises at least one aftertreatment (5).

31. The method of claim 21, wherein at least two paint coats are applied in (4).

32. The method of claim 21, wherein cathodic electrocoating is carried out in (4).

33. The method of claim 21, wherein powder coating is carried out in (4).

34. The method of claim 21, wherein the copolymer comprises at least one monomer (B1) and at least one monomer (B2).

35. The method of claim 34, wherein the amount of (A) is from 50% to 90%, the amount of (B1) is from 5% to 45%, the amount of (B2) is from 5% to 45%, and the amount of (C) is from 0% to 20% by weight.

36. The method of claim 21, wherein the formulation further comprises at least one metal ion selected from the group consisting of Zn, Mg, Ca, and Al.

37. The method of claim 21, wherein the thickness of the conversion coat is from 0.01 to 3 μm.

38. The method of claim 21, wherein the amount of the copolymer X1 in the conversion coat is at least 20% by weight based on the amount of all the components of the conversion coat.

39. The method of claim 21, wherein the thickness of the metallic layer is from 0.25 to 2.5 mm.

40. The method of claim 21, wherein the shaped body is at least one selected from the group consisting of parts of automobile bodies, truck bodies, casings for household appliances, casings for industrial appliances, structural elements in the architectural sector, furniture, and structural elements for furniture.
